(19) United States
(12) Patent Application Publication
(10) Pub. No.: US 2006/0220822 A1
(43) Pub. Date: Oct. 5, 2006

(54) Exterior safety seatbelt light

(76) Inventor: Lorenzo Fitzpatrick III, Canton, OH (US)

Correspondence Address: Lorenzo Fitzpatrick III, c/o N. Smallwood, PO Box 21443, Canton, OH, 44701-1443, US

(21) Appl. No.: 11/081,404

(22) Filed: Mar. 17, 2005

(51) Int. Cl. B60Q 1/26

(52) U.S. Cl. 340/468

(57) ABSTRACT

The Exterior Safety Seatbelt Light is designed to be used as an automobile safety feature used primarily to enforce state seatbelt laws. A secondary use may be to assist in processing automobile accident insurance claims. The lights will be located on the front, sides, and rear of vehicles, so as to be in viewed clearly by traffic moving in any direction.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The Exterior Safety Seatbelt Light is a safety concept that to my knowledge doesn't exist in the automobile marketplace at this time. It would be an additional safety feature to help enforce state seatbelt laws by determining if seatbelts are connected even during foul weather or night conditions. The connection can also be detected on automobiles with tinted windows.

### BRIEF SUMMARY OF THE INVENTION

The primary function of the Exterior Safety Seatbelt Light is enforcing safety. To make law enforcement, as well as the general public and, in some cases, insurance companies aware of who in the vehicle is riding safely by being secured by their seatbelt. This concept is designed to work by a series of exterior lights placed in main optical access viewing areas on all vehicles.

### BREIF DESCRIPTION OF THE SEVERAL VIEWS OF THE DRAWING

FIG. 1 is a front view of the cover for the Exterior Safety Seatbelt Light, which is triangular in shape, so as to distinguish it from other automobile indication lights.

FIG. 2 is a side-view of the Exterior Safety Seatbelt Light, which will be on the front and rear side doors of a 4-door automobile. On 2-door models, the rear side lights can still be positioned in approximately the same location.

FIG. 3 is a rear-view of the Exterior Safety Seatbelt Light. The lights may be displayed near the license plate to be viewed clearly.

FIG. 4 is the front-view of the Exterior Safety Seatbelt Light and may be located on the slope of the hood or on the front grill assembly area to be viewed clearly.

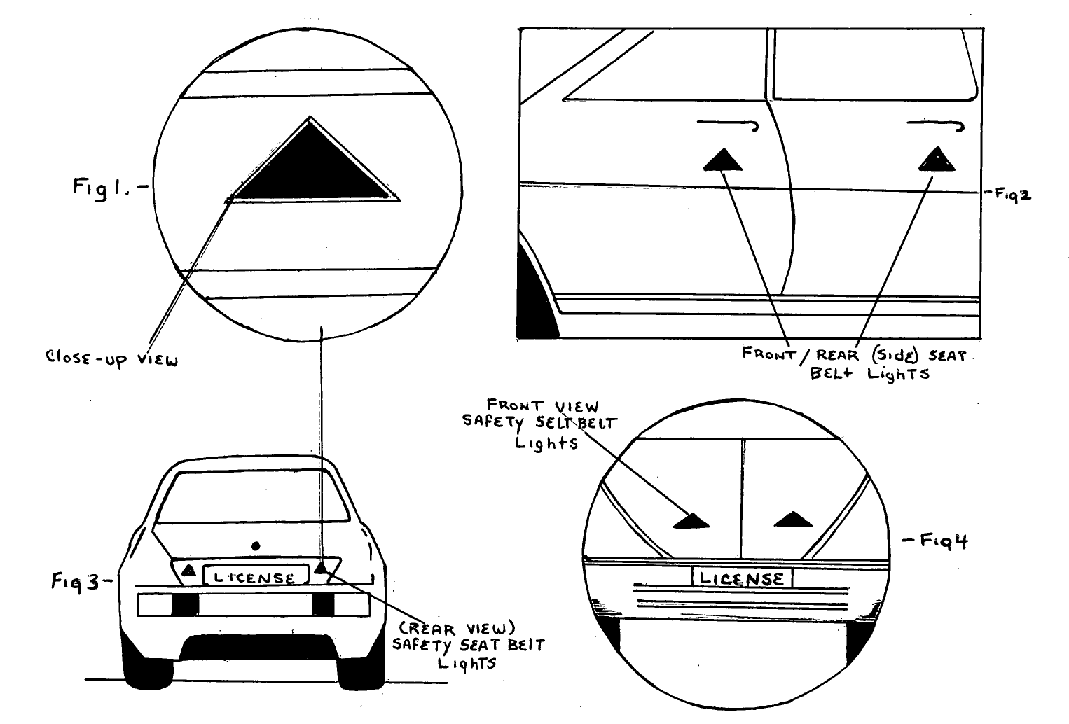

### DETAILED DESCRIPTION OF THE INVENTION

1. The Exterior Safety Seatbelt Light is a highly fluorescent light bulb with a cover of dull, durable plastic. The cover is triangular in shape with a height and width of one (1) inch. The color of the cover is green to indicate safety and can be likened to the meaning of the green color in a traffic signal.
2. It will be placed on the side doors, front slope of the hood or grill assembly, and on the rear panels near the license plate of all vehicles to provide clear viewing for traffic traveling in any direction.
3. The Exterior Safety Seatbelt Light will have to have a separate connection feed to an automobile power source, so that as soon as the seatbelts are connected, the system of lights will illuminate even if the engine is not running. In the case of an accident, the Exterior Safety Seatbelt Light will be illuminated even if the engine has shut down.
4. This lighting system would also add style to the outside appearance of the automobile body itself. The triangular shape may be formatted to illuminate the automobile company's logo on the sides of the automobile.

What is claimed as being new and desired to be protected by Letters Patent of the U.S. is as follows:

1. A new safety seatbelt lighting system for use as an additional automobile safety feature, said safety feature is comprised of:
a highly fluorescent light bulb to be illuminated through;
a green triangular piece of dull durable plastic, one (1) inch in height and width.

2. The new safety seatbelt lighting system indicated in claim 1 can be used to enforce state seatbelt laws and aid in automobile insurance claims.

3. The new safety seatbelt lighting system indicated in claim 1 can be used to enhance the quality and safety when manufacturing automobiles.
